(19) United States
(12) Patent Application Publication
(10) Pub. No.: US 2015/0233194 A1
(43) Pub. Date: Aug. 20, 2015

(54) Non-Marking Pipeline Slips

(71) Applicant: Benton Frederick Baugh, Houston, TX (US)

(72) Inventor: Benton Frederick Baugh, Houston, TX (US)

(21) Appl. No.: 14/180,880

(22) Filed: Feb. 14, 2014

(51) Int. Cl. E21B 19/10; F16L 55/07

(52) U.S. Cl. CPC E21B 19/10; F16L 55/07

(57) ABSTRACT

Non-marking slips for engaging a pipe surface for failsafe support in a first direction, comprising the pipe surface having a pipe centerline, one or more slip segments having a first slip surface which proximately conforms to the pipe surface, a tapered slip surface at a taper angle to the pipe centerline, the taper angle having a taper angle sine, a first coefficient of friction between the pipe surface and the first slip surface, a slip body having one or more slip body tapered surfaces proximately parallel to the tapered slip surface, a low friction bearing material between the slip body tapered surface and the tapered slip surface such that there is a second coefficient of friction between the slip body tapered surface and the tapered slip surface, such that the combination of the second coefficient of friction plus the taper angle sine is less than the first coefficient of friction, such that when loaded from a first direction, slippage will occur between the slip body tapered surface and the tapered slip surface causing an increase in the normal load between the first slip surface and the pipe surface and therefore load supporting friction.

### TECHNICAL FIELD

This invention relates to the method of providing fixing a pig or tool within a pipeline for differential pressure operations without damaging the pipeline by slip tooth marks.

### BACKGROUND OF THE INVENTION

At certain temperatures and pressures in a pipeline, hydrates will form. Hydrates are a combination of hydrocarbon gases and water which resembles crushed ice and will completely block the flow in a pipeline. As hydrate formation is facilitated by higher pressure and lower temperature, subsea pipelines are particularly susceptible to hydrates. The ocean in deepwater is characteristically about 34 degrees F., and if there was not the gas volume inherent with significant pressure the pipeline would not exist.

When hydrates form, the typical solution has been to reduce the pressure as much as practical at the end of the pipeline and wait until they melt. This process can take several months with associated loss of revenue. A second method is to locally heat the area with a subsea heating module as is shown in U.S. Pat. No. 6,939,082. The application of this method has been restricted as the concern with hydrates has caused operators to apply insulation to the pipelines and this dampens the effectiveness of trying to get heat to the hydrate.

Even beyond the hydrate problem, the industry has lacked a method of fixing a pig or tool in a pipeline for the existence of pipelines as if the tool does not release, the pipeline is permanently blocked. A pig or tool which simply will not only not damage the internal surface of the pipeline but will also not wedge in place will offer an opportunity to substantially expand pipeline operations.

The problem is so expensive that the industry has not only gone to the expense of insulating pipelines, but literally installing double wall pipelines for insulation characteristics. If you imagine a double wall pipeline with gas flowing through the inner pipeline, the larger outer pipeline is likely more expensive than the inner one and then you have the problem of how you assemble one pipeline inside another.

### BRIEF SUMMARY OF THE INVENTION

The objective of this invention is to provide a method of providing a locking of a pig or tool in the bore of a pipeline against a relative vacuum in a subsea pipeline used to cause a hydrate blockage to disassociate.

A second objective of this method is to provide a high degree of assurance the pig or tool will release from the bore of the pipeline so as to not cause a major disruption of operations.

A third objective of this method is to not damage the pipeline in any way, including scratches which normally occur with conventional slips.

### BRIEF DESCRIPTION OF THE DRAWINGS

FIG. 1 is a view of an offshore platform and pipeline showing a hydrate formed in the pipeline and a prior art method of remediation.

FIG. 2 is graphical representation of hydrate formation criteria in a pipeline.

FIG. 3 is a view of an offshore platform and pipeline similar to FIG. 1 showing a hydrate formed in the pipeline and a prior art method of remediation including using a coiled tubing string to mechanically pull a local vacuum.

FIG. 4 is a view of an offshore platform and pipeline similar to FIG. 1 and FIG. 3 showing a hydrate formed in the pipeline and a method of the present invention remediating the hydrate.

FIG. 5 is a half section of the pipeline pig of the present method indicating the flow paths as the pipeline pig is being run into the pipeline.

FIG. 6 is a half section of the pipeline pig of the present method indicating the flow paths as the pipeline pig is located proximate the hydrate and is remediating the hydrate.

FIG. 7 is a half section of the pipeline pig of the present method indicating the flow paths as the flow to the pipeline pig is reversed to reset the tool for recovery.

FIG. 8 is a half section of the pipeline pig of the present method indicating the flow paths as the pipeline pig is being recovered from the pipeline.

FIG. 9 is an enlargement of a portion of FIG. 6 for clarity.

FIG. 10 is a quarter section graphic of a set of conventional slips except without the conventional sharp teeth to discuss the purpose of the sharp teeth.

FIG. 11 is a quarter section graphic of a set of conventional slips except with the conventional sharp teeth to discuss the purpose of the sharp teeth.

FIG. 12. is a quarter section of slips without sharp teeth which will provide failsafe support in a pipeline.

### DETAILED DESCRIPTION OF THE INVENTION

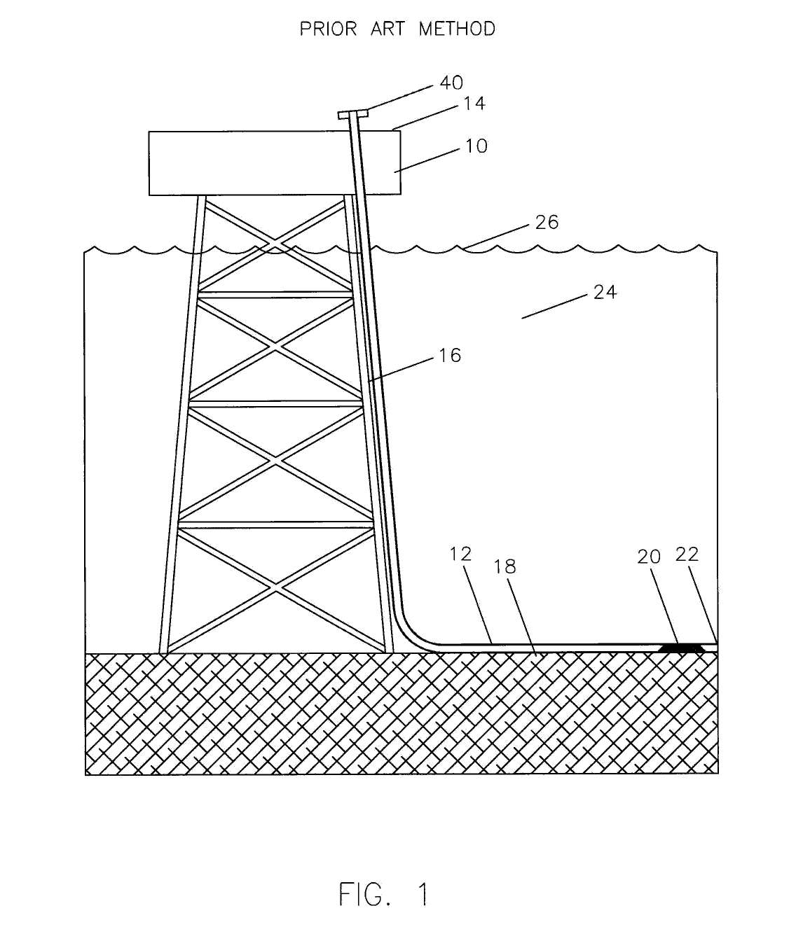

Referring now to FIG. 1, a platform 10 is shown with a pipeline 12 terminating above the deck 14, going down a side 16 of the platform, and away from the platform along the ocean floor 18. This would be a reasonable representation of a pipeline which is receiving gas or oil from the pipeline or is sending gas or oil from the platform to another location, e.g. to the shore. In this case a hydrate formation 20 is shown near the end 22 of the portion of the pipeline which is shown. The ocean 24 is shown with surface 26.

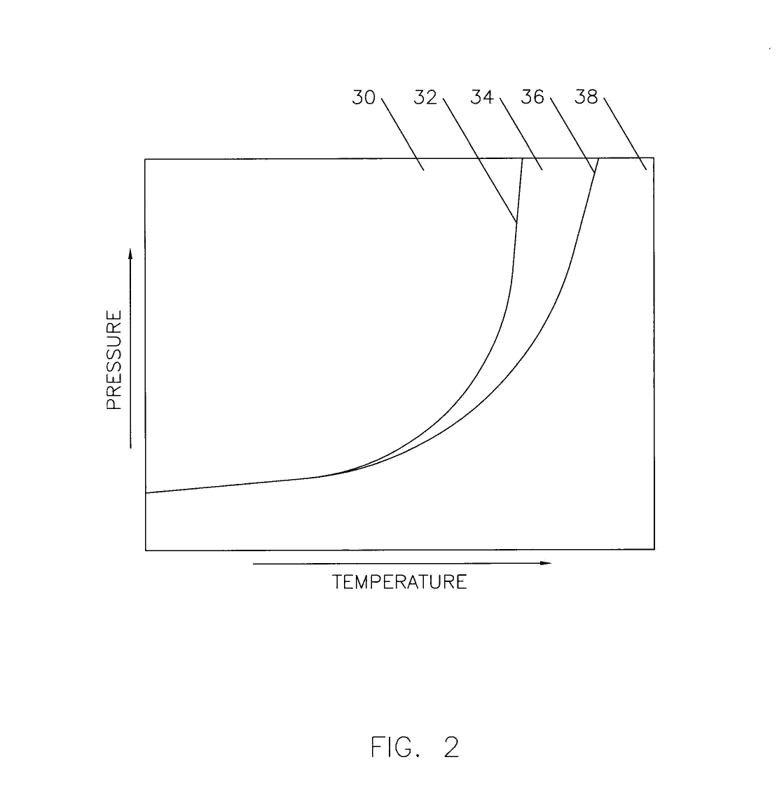

Referring now to FIG. 2, a graph is shown which shows a “sweet spot” range of temperature and pressure where hydrates form. There is a hydrate zone 30, a hydrate risk zone 32, a hydrate free zone 34, a formation curve 36, and a dissociation curve 38. As can be seen, one can escape from the hydrate zone 30 by increasing the temperature or decreasing the pressure. In the referenced U.S. Pat. No. 6,939,082, the objective was to escape the hydrate zone 30 by heating the pipeline. This requires going to the subsea site of the pipeline and locating the hydrate from outside the pipeline. The alternative which is addressed in the present invention is to reduce the pressure.

Referring again to FIG. 1, if appropriate valving 40 at the end of pipeline 12 is opened and the pressure within the pipeline is vented, the pressure proximate the hydrate formation 20 can be reduced. If that causes the hydrate formation 20 to disassociate, the problem is solved. If vacuum equipment (not shown) is attached to the valving 40 and a vacuum is drawn at that location, the pressure will be reduced by only 14.7 p.s.i., which is not likely to make a difference.

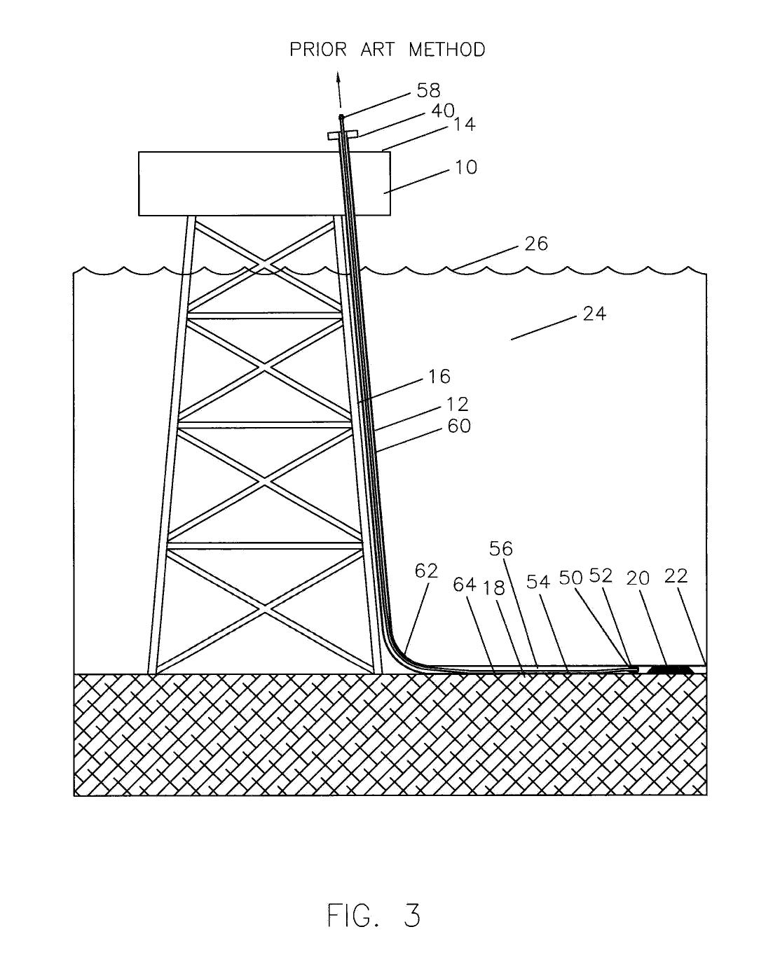

Referring now to FIG. 3, an alternate proposal for reducing the pressure proximate the hydrate formation 20 is illustrated. A pipeline pig 50 with sealing cup 52 is run into the pipeline pulling coiled tubing string 54 as it moves forward. As it moves forward, it is pushed forward by flow into the annular area 56 outside the coiled tubing 54 and inside the pipeline 12. Any gas or liquid in front of pipeline pig 50 is forced by up the bore of coiled tubing string 54 and to platform 10 for disposal. When the pipeline pig 50 is nearing the hydrate formation 20, valve 58 on the coiled tubing is closed and the coiled tubing string 54 is pulled in tension. This tension will effectively pull a relative vacuum between the hydrate blockage 20 and the pipeline pig 50, which if sufficient will cause the hydrate blockage 20 to disassociate or melt. The vacuum is called relative as it is relative to the pressure in the pipeline. If the pipeline pressure is 1000 p.s.i. and the pressure is reduced to 600 p.s.i. to remediate the hydrate, it is a relative vacuum of 400 p.s.i., but it still has a 400 p.s.i. pressure. For this method to be effective it is important to get the pipeline pig 50 as close to the hydrate blockage 20 as practical to reduce the volume of gas to be expanded to lower the pressure. Unfortunately this means several factors are working against the effectiveness of the method. Some of these factors are (1) the weight of the coiled tubing in the pipeline riser section 60 of the pipeline 12, (2) the drag around the bends 62 in the pipeline which are literally requiring enough force to bend the coiled tubing as it goes around the bend, (3) the simple weight friction 64 of the coiled tubing string 54 along the pipeline 12, and (4) the sealing friction of the sealing cup 52 in the bore of the pipeline 12. All of these factors are working against the effectiveness of the system, when the strength of the coiled tubing may not be sufficient to pull and adequate relative vacuum in the first place.

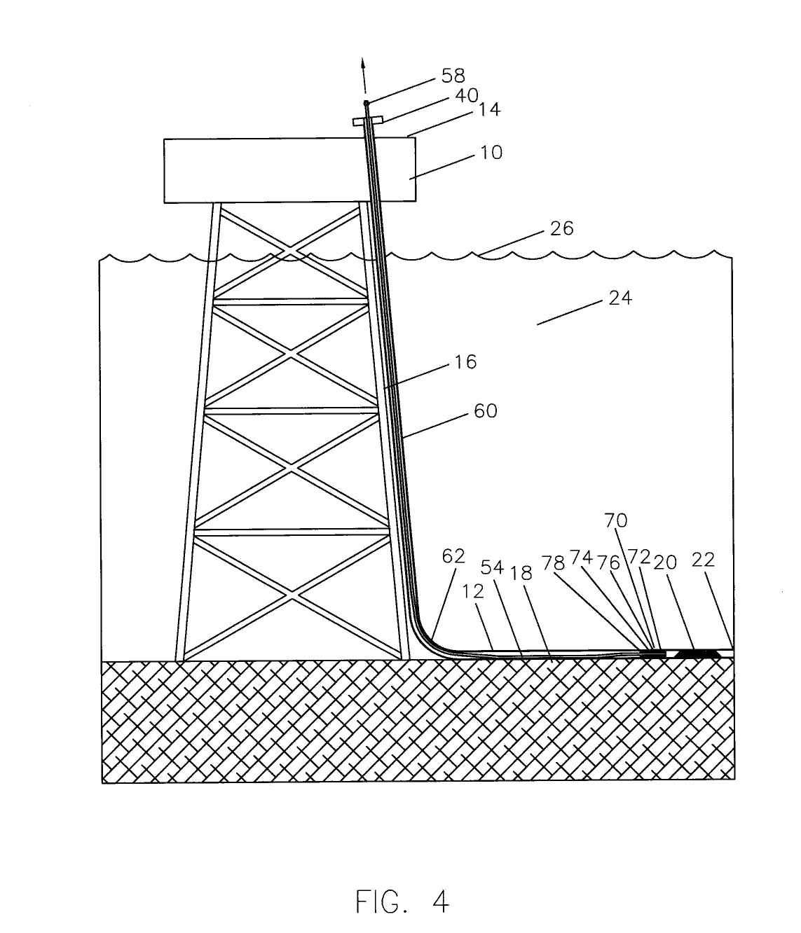

Referring now to FIG. 4, a figure is shown similar to FIG. 3, except the pipeline pig 50 of FIG. 3 is replaced with combo pig 70 of the present invention. Combo pig 70 comprises sealing cup 72, motor 74, pump 76, and slips 78, as will be described in subsequent figures. Combo pig 70 is designed to be moved into the pipeline 12 as pipeline pig 50 was, however, it is not important that it is moved near to the hydrate blockage 20. It needs to be moved as closely as practical to the same elevation as the hydrate blockage 20 so that the relative vacuum pulled in front of combo pig 70 will be the relative vacuum which the hydrate blockage 20 sees. In many cases, it means the pig can be run to the bottom of the pipeline riser section 60 and not even be required to navigate the bends 62. At this point slips 78 are set on the internal diameter of the pipeline and the motor 74 is run to drive the pump 76 to displace fluids and gases in front of combo pig 70 up the bore of coiled tubing string 54 to pull a relative vacuum on the hydrate. As the force of the differential pressure across the sealing cup 72 is withstood by the slips 78, the coiled tubing string 54 is not loaded or stretched. If the relative vacuum is not sufficient to remediate the hydrate, the pump motor combination simply continues to run until it is. As the hydrate begins to disassociate or melt and releases gases and liquids to functionally reduce the extent of the relative vacuum, the pump/motor combination continues to run to remove the released gases and liquids.

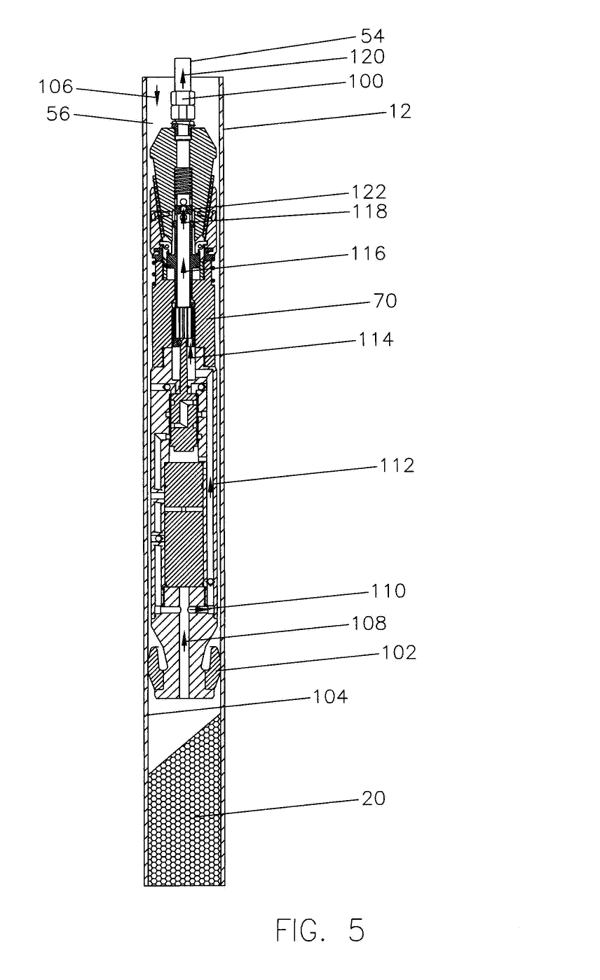

Referring now to FIG. 5, combo pig 70 is shown in pipeline 12 with coiled tubing string 54 connected to combo pig 70 with connection 100 and with sealing cup 102 engaging the internal bore 104 of pipeline 12. Arrow 106 illustrates the direction of flow in the annular area 56 which engages sealing cup 102 and moves the combo pig 70 and coiled tubing string 54 towards the hydrate blockage 20. Fluids and gases between combo pig 70 and hydrate blockage 20 return thru combo pig 70 and up the internal bore of the coiled tubing string 54 as indicated by arrows 108-120. This includes passing through a check valve 122.

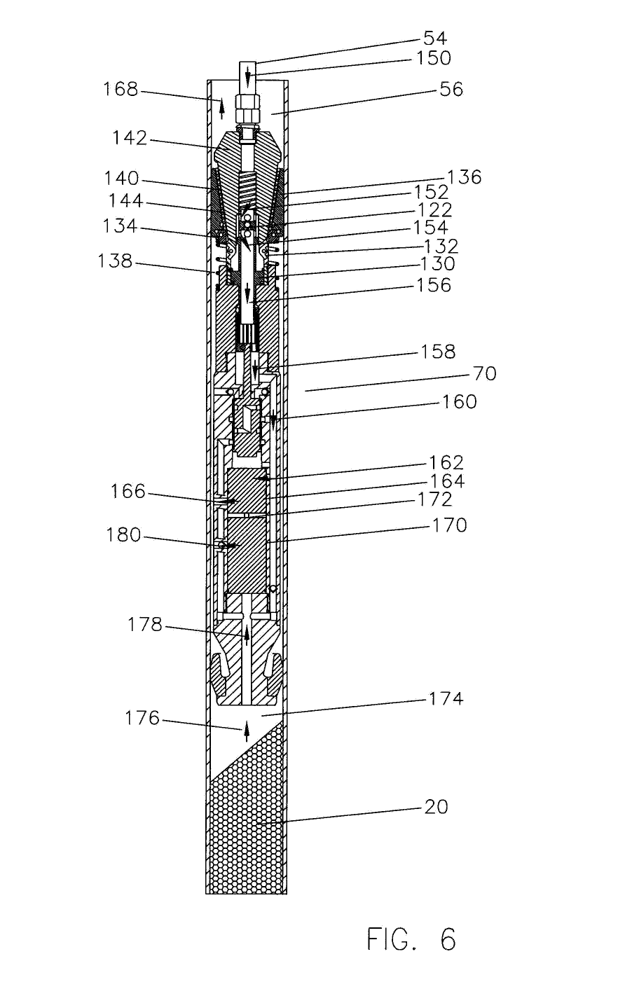

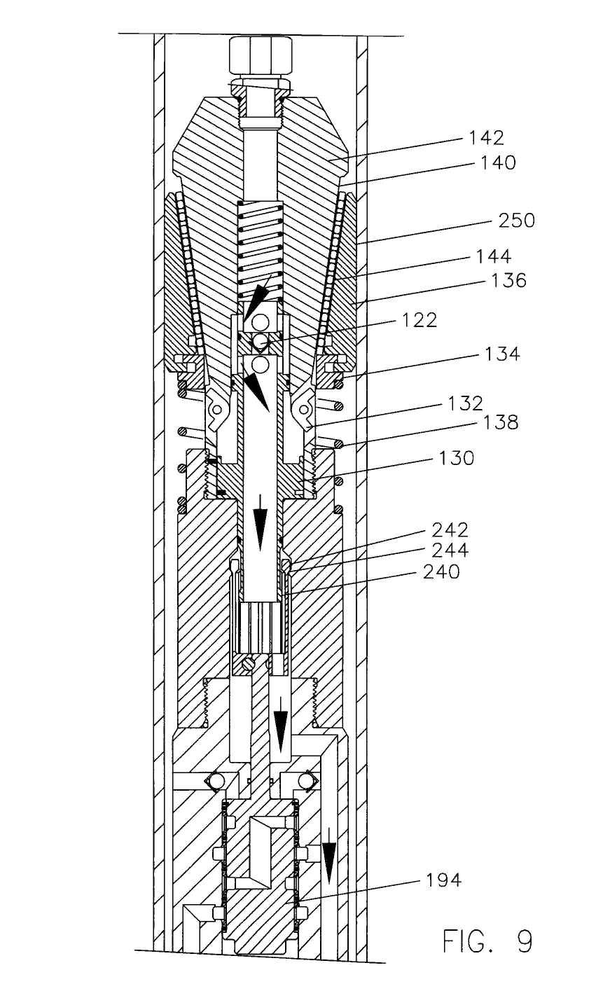

Referring now to FIG. 6, when combo pig 70 is as far into the pipeline as desired, flow is reversed and pumped into the coiled tubing string 54 to combo pig 70. As flow will not go through check valve 122 in the reverse direction, sleeve 130 is moved downwardly on FIG. 6. This movement of sleeve 130 releases pivoting dogs 132 which in turn releases ring 134 which is attached to slip segments 136. Spring 138 pushes slip segments 136 upwardly on FIG. 6, and slip segments 136 ride on tapers 140 on top sub 142, with low friction bearings 144 there between. The purpose of low friction bearings 144 will be discussed in FIG. 9. The flow along the coiled tubing string 74 takes the path indicated by arrows 150-162 to power a motor 164. Exhaust from motor 164 flows back to the annular area 56 as indicated by arrows 166 and 168. Motor 164 powers pump 170 by shaft 172. Pump 170 draws fluids and gases from the area 174 between the combo pig 70 and the hydrate blockage 20 as indicated by arrows 176 and 178. Flow from pump 170 returns to the annular area 56 as indicated by arrows 180 and 168. By this method flow from the coiled tubing string 54 powers motor 164 to drive pump 170 to pull a relative vacuum in area 170 or effectively on the hydrate blockage 20. The longer the pump and motor combination run, the lower the pressure in the relative vacuum becomes.

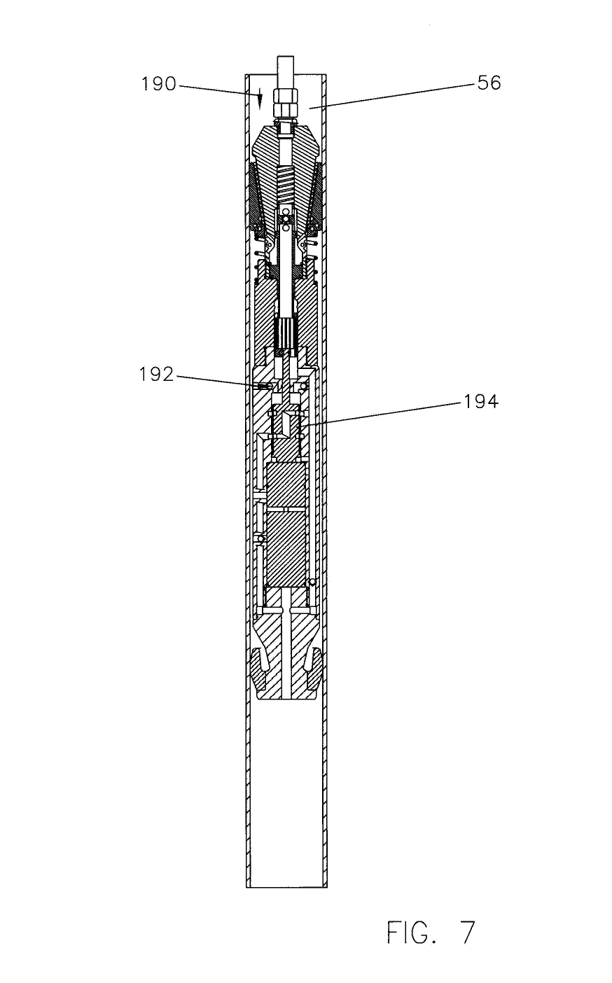

Referring now to FIG. 7, flow into the annular area 56 as indicated by arrows 190 and 192 shifts valve 194 downwardly in the figure.

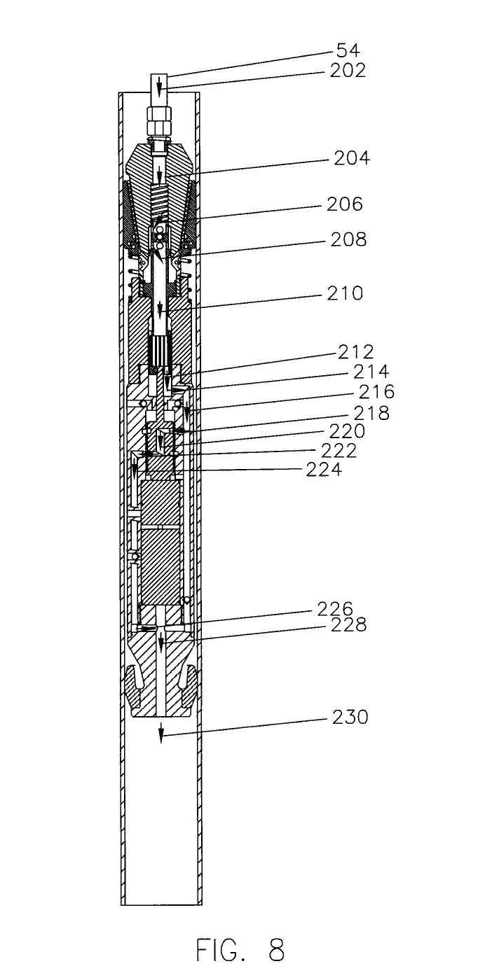

Referring now to FIG. 8, arrows 202-230 indicate the newly opened flow path which allows flow from the coiled tubing string 54 to flow to the front of the combo pig 70 to repressure the area which was subjected to a partial vacuum and then to provide fluid or gas volume in front of the combo pig 70 as it is being retrieved so it will not tend to cause another partial vacuum.

Referring now to FIG. 9, an enlarged portion of FIG. 6 is shown. As can be seen, sleeve 130 has been shifted downwardly but valve 194 has not been shifted downwardly at this time. Enlarged portion 240 of sleeve 130 has been moved downwardly from enlarged portion 242 of slotted collet portion 244 of valve 194. This means that when enough pressure force is imparted to valve 194 (as discussed in FIG. 7) enlarged portion 242 will move from behind shoulder 244 and allow valve 194 to move downwardly.

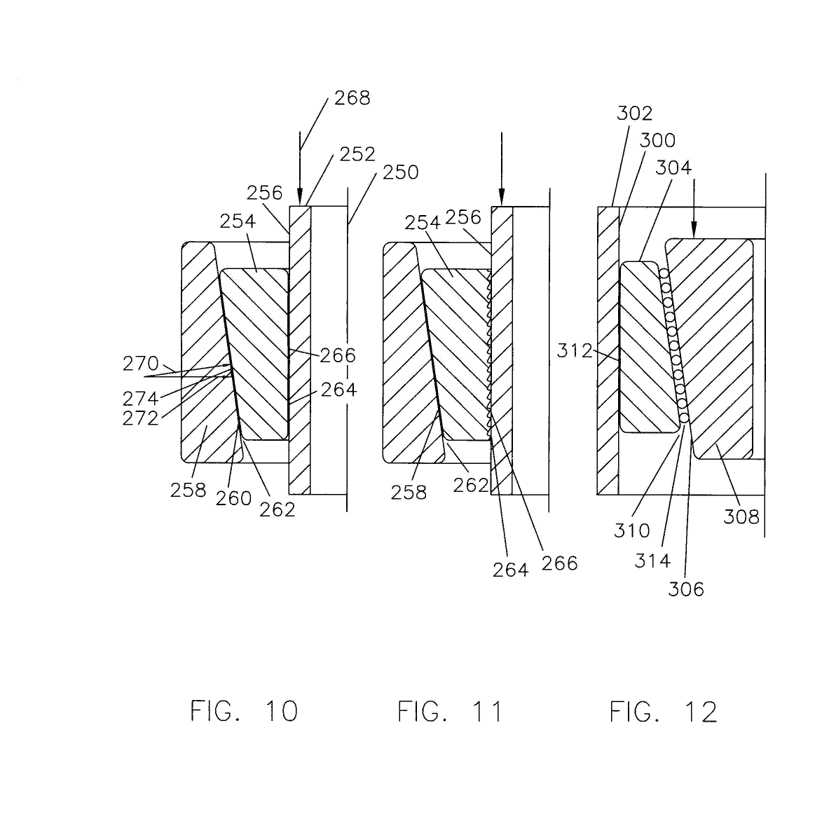

Slip segments 136 are shown engaged with internal bore 104 of pipeline 12, but have a smooth engagement surface rather than the sharp teeth as are characteristic of normal slips. The reason this is possible is due to the low friction bearings 144, as will be described in FIGS. 10-12. This is extremely important as the extent to which normal sharp toothed slips will cut into the pipeline internal bore is unacceptable in this service.

Referring now to FIG. 10, a quarter section graphic of a slip assembly without sharp teeth is shown. Pipe 250 is shown around centerline 252. Slip insert 254 is touching the outside diameter 256 of pipe 250 and is contacting slip bowl 258 on the opposite side. The contact surface 260 between slip insert 254 and slip bowl 258 is tapered at approximately eight degrees as is conventional in the art. The coefficient of friction 262 at contact surface 260 and the coefficient of friction 264 at contact surface 266 between the slip insert 254 and the outer diameter 256 of pipe 250 are likely to be the same. When pipe 250 is loaded downwardly by the force indicated as 268, slippage will occur at either at contact surface 260 or at contact surface 266. As the coefficient of friction is the same for both surfaces and the eight degree angle of surface 260 gives an additional resisting force, the slippage will occur at surface 260. This is shown graphically with 270 being the normal (perpendicular) force to the surface, 272 being the horizontal component of the force, and 274 being the vertical component. There is no comparable vertical component associated with the normal force to the contact surface 266 as the force is simply horizontal. This means the pipe 250 will simply slip at contact surface 266 and fall rather than the slip insert 250 sliding down the taper and wedging more tightly to grip the pipe.

Referring now to FIG. 11, the same general geometry as was in FIG. 10 is repeated, however, sharp teeth 280 are introduced at interface 282. It is a general industry practice to equate the effect of sharp teeth to be a coefficient of friction of 0.5, whereas the typical coefficient of friction at a surface like 284 to be 0.1. As the sliding friction force is a product of the normal force times the coefficient of friction, the high coefficient of friction at interface 282 will more than offset the vertical component 274 as seen in FIG. 10, so the slip insert 286 will slide down the taper 288 and more tightly grip the pipe for failsafe support.

Referring now to FIG. 12, instead of gripping on the outside diameter of a pipe, the need is to grip on the inside diameter 300 of a pipeline 302. It is not acceptable to use sharp teeth on the slip insert 304 as the sharp teeth put potentially damaging teeth marks on the inside diameter 300. A tapered surface 306 exists on the inner body 308. The method used herein is for the coefficient of friction at interface 310 to be lower than the 0.1 coefficient of friction at interface 312. The method for accomplishing this is to incorporate needle roller bearings 314 into the interface 310 which will have a coefficient of friction approximately 0.01 or very close to zero. Other bearings such as Teflon bearings can be used, however, the simple rolling friction of the needle roller bearings is very predictable. Using this method the problem of non-marking failsafe gripping on the inside of a pipeline is resolved. The needle roller bearings provide another feature, the elimination of hysteresis. Hysteresis in this application means that friction works against you to tighten something such as setting the slips, but when set the friction in the opposite direction can lock it in place. In simpler terms, it will get stuck. Getting stuck remotely inside a pipeline is a very bad and expensive condition. As the needle roller bearings roll into position, they simply roll out also and therefore do not get stuck.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### SEQUENCE LISTING

N/A

That which is claimed is:

1. Non-marking slips for engaging a pipe surface for failsafe support in a first direction, comprising:
said pipe surface having a pipe centerline,
one or more slip segments having a first slip surface which proximately conforms to said pipe surface, a tapered slip surface at a taper angle to said pipe centerline, said taper angle having a taper angle sine,
a first coefficient of friction between said pipe surface and said first slip surface,
a slip body having one or more slip body tapered surfaces proximately parallel to said tapered slip surface,
a low friction bearing material between said slip body tapered surface and said tapered slip surface such that there is a second coefficient of friction between said slip body tapered surface and said tapered slip surface,
such that the combination of said second coefficient of friction plus the taper angle sine is less than said first coefficient of friction,
such that when loaded from a first direction, slippage will occur between said slip body tapered surface and said tapered slip surface causing an increase in the normal load between said first slip surface and said pipe surface and therefore load supporting friction.

2. The method of claim 1 further comprising said slips are failsafe.

3. The method of claim 1 further comprising said slips are toothless.

4. The method of claim 1, further comprising said pipe surface is the internal bore of a pipe.

5. The method of claim 4, further comprising said pipe is a subsea pipeline.

6. The method of claim 1, further comprising said pipe surface is the outer diameter of a pipe.

7. The method of claim 1 further comprising said low friction bearing material comprises a multiplicity of roller bearings.

8. The method of claim 1 further comprising said low friction bearing material comprises a Teflon material.

9. The method of providing failsafe slip support within a pipe in a first direction without marking the bore of said pipe comprising:
providing a central body having a centerline,
said central body having two or more body inclined surfaces inclined at an angle relative to said centerline,
providing two or more slip inserts adapted to engage said bore of said pipe and having an insert inclined surface approximately parallel to one of said body inclined surfaces,
providing a bearing between said body inclined surfaces and said insert inclined surfaces which has a coefficient of friction lower than the coefficient of friction between said slip inserts and said bore of said pipeline,
such that a force on said central body in said first direction will initiate slippage at said bearing rather than at the contact of said slip inserts with said bore of said pipe.

10. The method of claim 9 further comprising said pipe is a subsea pipeline.

11. The method of claim 9 further comprising said bearing comprises a multiplicity of roller bearings.

12. The method of claim 9 further comprising said bearing comprises a Teflon material.

13. The method of claim 9 further comprising said one or more slip inserts do not have sharp teeth.

14. The method of claim 9 further comprising said one or more slip inserts are of a material which is softer than said pipe.

15. The method of claim 9 further comprising said one or more slip inserts are made of brass.
